(19) United States
(12) Patent Application Publication
(10) Pub. No.: US 2009/0021458 A1
(43) Pub. Date: Jan. 22, 2009

(54) High contrast liquid crystal display

(76) Inventors: Valter Drazic, Betton (FR); Estill Thone Hall, JR., Fishers, IN (US); Eugene Murphy O'Donnell, Fishers, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/665,189

(22) PCT Filed: Oct. 11, 2005
(86) PCT No.: PCT/US05/36323

§ 371 Date: Apr. 11, 2007

Related U.S. Application Data
(60) Provisional application No. 60/618,694, filed on Oct. 14, 2004.

(51) Int. Cl. G09G 3/36

(52) U.S. Cl. 345/87

(57) ABSTRACT

A projection system including a first imager that is an organic light emitting diode (OLED) imager configured to modulate a light band on a pixel-by-pixel basis proportional to gray scale values provided for each pixel of the image to provide a first output matrix and a second imager positioned and configured to receive the first output matrix of modulated pixels of light from the first imager on a pixel-by-pixel basis proportional to a second gray scale value provided for each pixel of the image is disclosed.

### CROSS-REFERENCE TO RELATED APPLICATIONS

This application claims the benefit of U.S. Provisional Patent Application Ser. No. 60/618,694 (Atty Docket PU040280), entitled “HIGH CONTRAST AND LOW CONSUMPTION FLAT MONITOR” and filed Oct. 14, 2004, which is incorporated by reference herein in its entirety.

### BACKGROUND OF THE INVENTION

1. Field of the Invention

The invention relates generally to a projection display and, in particular to a projection display having a two-stage projector architecture.

2. Description of the Background Art

Liquid crystal displays (LCDs) are becoming increasingly prevalent in imaging devices such as rear projection television (RPTV). In an LCD system, projected light is polarized by a polarizing beam splitter (PBS) and directed onto a LCD imager or light engine comprising a matrix of pixels. Throughout this specification, and consistent with the practice of the relevant art, the term pixel is used to designate a small area or dot of an image, the corresponding portion of a light transmission, and the portion of an imager producing that light transmission.

Each pixel of the imager modulates the light incident on it according to a gray-scale factor input to the imager or light engine to form a matrix of discrete modulated light signals or pixels. The matrix of modulated light signals is reflected or output from the imager and directed to a system of projection lenses which project the modulated light onto a display screen, combining the pixels of light to form a viewable image. In this system, the gray-scale variation from pixel to pixel is limited by the number of bits used to process the image signal. The contrast ratio from bright state (i.e., maximum light) to dark state (i.e., minimum light) is limited by the leakage of light in the imager.

One of the major disadvantages of existing LCD systems is the difficulty in reducing the amount of light in the dark state, and the resulting difficulty in providing outstanding contrast ratios. One of the reasons is because it's backlighting is always ON, whatever the picture content.

In addition, since the input is a fixed number of bits (e.g., 8, 10 etc.), which must describe the full scale of light, there tends to be very few bits available to describe subtle differences in darker areas of the picture. This may lead to contouring artifacts.

What is needed is a projection system that enhances the contrast ratio for video images, particularly in the dark state, and that reduces contouring artifacts.

### SUMMARY OF THE INVENTION

The present invention provides a projection system having improved contrast and contouring of a light signal on a pixel-by pixel basis using a two-stage projection architecture, thus improving all video pictures. In an exemplary embodiment of the present invention, this projection system includes a first imager that is an organic light emitting diode (OLED) imager configured to modulate a light band on a pixel-by-pixel basis proportional to gray scale values provided for each pixel of the image to provide a first output matrix. A second imager is positioned and configured to receive the first output matrix of modulated pixels of light from the first imager on a pixel-by-pixel basis proportional to a second gray scale value provided for each pixel of the image. Each pixel of the second imager provides a light output of intensity proportional to a modulated light output of a corresponding pixel in the first imager and a selected gray scale value for that pixel in the second imager.

### BRIEF DESCRIPTION OF THE DRAWINGS

The invention will now be described in greater detail, with relation to the accompanying drawings, in which

FIG. 1 shows a block diagram of an LCD projection system with a two-stage projection architecture according to an exemplary embodiment of the present invention.

### DETAILED DESCRIPTION

The invention proposes a “two-stage” approach to improving LCD contrast and reducing “contouring” artifacts in dark program material. It achieves this by using an organic light emitting diode (OLED) imager to modulate pixel-by-pixel the light input to an LCD imager. The OLED imager has the same pitch as the LCD imager and it's purpose is twofold: to backlight the LCD panel and modulate the content of the LCD panel.

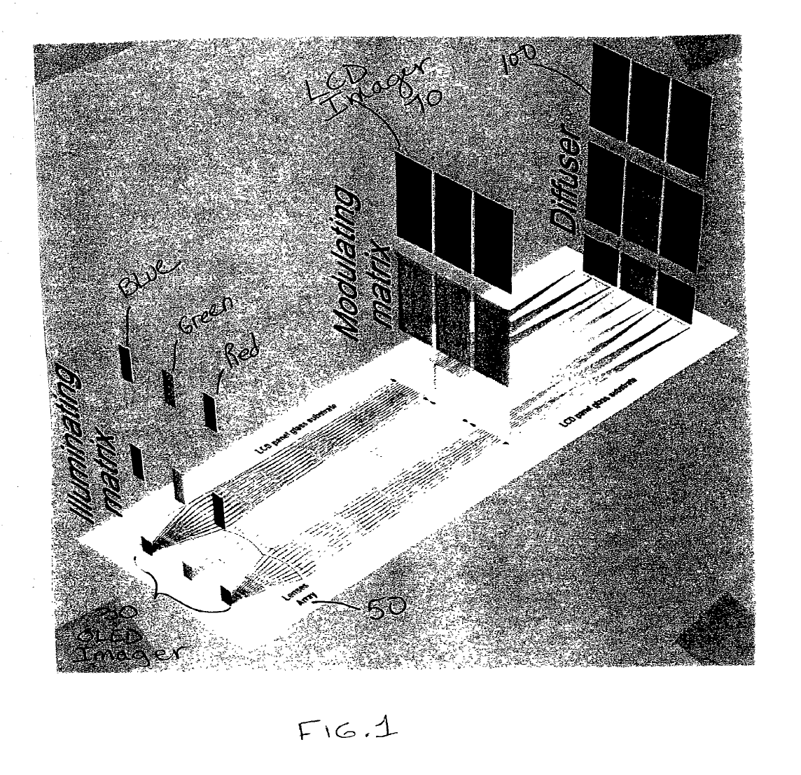

The present invention provides a two-stage projection system using a combination of LCD and OLED imagers. In an exemplary embodiment of the present invention, illustrated in FIG. 1, a two-stage projection system comprises a first imaging stage comprising an OLED imager 30 and a second imaging stage having an LCD imager 70 disposed to receive the modulated output of the OLED imager 30 for temporally modulating the previously modulated output of the OLED imager 30.

The first imager that is an organic light emitting diode (OLED) imager configured to modulate a light band on a pixel-by-pixel basis proportional to gray scale values provided for each pixel of the image to provide a first output matrix. A second imager is positioned and configured to receive the first output matrix of modulated pixels of light from the first imager on a pixel-by-pixel basis proportional to a second gray scale value provided for each pixel of the image. Each pixel of the second imager provides a light output of intensity proportional to a modulated light output of a corresponding pixel in the first imager and a selected gray scale value for that pixel in the second imager.

A lens array 50 is disposed between the first imaging stage and the second imaging stage. The lens array projects individual pixels of light from the first OLED 30 onto corresponding pixels of the LCD 70. A suitable lens array is described in co-pending Patent Cooperation Treaty application US03/37978 (filed Nov. 26, 2003 entitled “Two-Stage Projector Architecture) for a system in which the second imager 70 is the same size as the first imager 30, thereby requiring a unity magnification. Projection systems with different size imagers are also contemplated within the scope of this invention, whereby lens array 50 would have a non-unity magnification.

Referring to FIG. 1, in this system, the light output of a particular pixel (i,j) on a diffuser 100 is given by the product of the light emitted by the (i,j) pixel of the illumination matrix (OLED imager 30) incident on the given pixel in the LCD imager 70 (modulating matrix), the gray scale selected by the LCD pixel, and the gray scale selected by the illumination matrix:

L=L₀×G₁×G₂

Now, L₀ is a constant for a given pixel (being a function of maximum driving current within that pixel). Thus, the light output is really determined by the gray scales selected by this pixel on each imager. If we normalize the gray scales to 1 maximum and assume each imager has, a very modest contrast ratio of 200:1, then the bright state of a pixel is 1, and the dark state of a pixel is 1/200 (not zero because of leakage). Thus, for the combination system, we have a luminance range of:

Lₘₐₓ=1×1=1

and

Lₘᵢₙ=0.005×0.005=0.000025

which gives a contrast ratio of 1/0.000025:1=40,000:1. Also, since we have a large number of bits available (2× the imager bit depth), then we can all but eliminate contouring.

The improved addressing depth is moreover not achieved by doubling the bandwidth of the addressing since the same signal as in a one LCD panel system applies to both the drivers of the OLED and the LCD matrices.

Another advantage is that the pixels that are darker or off have either much less power consumption than a traditional backlighting or non-power consumption at all if the pixels are off.

A key element for this function is the imaging array lens system between the two imagers. Its function is to image each pixel of the illuminating matrix onto the diffuser and at the same time it illuminates the corresponding pixel of the LCD matrix without light spilling over to neighboring pixels to avoid cross-talk. For that, the radiation emitted by each pixel of the illuminating matrix needs to be constrained into a cone of ±14 degrees with the design shown in FIG. 1.

There are two different configurations possible for making the colors. Either, the illuminating matrix consists of RGB pixels and the LCD matrix does not have corresponding RGB color filters (shown in FIG. 1), or the illuminating pixels emit white light, and the modulating LCD matrix needs to have RGB triplets.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. An image projection system for projecting an image comprising a matrix of light pixels having modulated luminance, the projection system comprising:
a first imager configured to modulate light on a pixel-by-pixel basis proportional to gray scale values provided for each pixel of the image to provide a first output matrix; and
a second imager positioned and configured to receive the first output matrix of modulated pixels of light and modulate the individual modulated pixels of light from said first imager on a pixel-by-pixel basis proportional to a second gray scale vale provided for each pixel of said image, wherein one of said first imager and said second imager is an organic light emitting diode (OLED) imager.

2. The image projection system of claim 1 wherein one of the first imager and the second imager is a liquid crystal on silicon (LCOS) imager.

3. The image projection system of claim 1 further comprising a relay lens system directing modulated light output from each pixel of said first imager to a corresponding pixel of said second imager.

4. The image projection system of claim 3 wherein the relay lens system is symmetrical.

5. A light projection system for projecting an image comprising a matrix of light pixels having modulated luminance, the projection system comprising:
a first imager configured to modulate light on a pixel-by-pixel basis proportional to gray scale values provided for each pixel of the image to provide a first output matrix; and
a second imager positioned and configured to receive the first output matrix of modulated pixels of light and modulate the individual modulated pixels of light from said first imager on a pixel-by-pixel basis proportional to a second gray scale vale provided for each pixel of said image, wherein one of said first imager and said second imager is an organic light emitting diode (OLED) imager.

6. The light projection system of claim 5 wherein one of the first imager and the second imager is a liquid crystal on silicon (LCOS) imager.

7. The light projection system of claim 5 further comprising a relay lens system directing modulated light output from each pixel of said first imager to a corresponding pixel of said second imager.

8. The light projection system of claim 7 wherein the relay lens system is symmetrical.
